(19) United States
(12) Patent Application Publication
(10) Pub. No.: US 2005/0121642 A1
(43) Pub. Date: Jun. 9, 2005

(54) Replacement or aftermarket leak-proof brake bleeder

(76) Inventor: Alan H. Purdy, San Marcos, CA (US)

Correspondence Address: Alan H. Purdy, 941 Cycad Dr., San Marcos, CA, 92078, US

(21) Appl. No.: 10/730,515

(22) Filed: Dec. 4, 2003

(51) Int. Cl. F16K 31/00

(52) U.S. Cl. 251/343

(57) ABSTRACT

A replacement brake bleeder valve for leaky original equipment manufacturer brake bleeder valves. It includes: A replacement valve body that matches the original equipment manufacturer brake cylinder threads and seals to the brake cylinder to prevent brake fluid or air leakage. A replacement bleeder valve that opens or closes brake fluid or air access to the original manufacturer brake cylinder, and an O-ring seal secured between the replacement valve body and the replacement bleeder valve to prevent the leakage of brake fluid or air while bleeding the brakes.

### BACKGROUND—FIELD OF INVENTION

This invention relates to the problem of leakage of brake fluid or air when servicing the brakes of automobiles and other vehicles including aircraft. When servicing the brakes on vehicles, it is common for air to enter the brake system where it causes the brakes to malfunction. To eliminate this air, the brakes are bled, i.e. brake fluid is extracted or injected at the wheel brake cylinder until the air is eliminated.

### BACKGROUND—DISCUSSION OF PRIOR ART

In most conditions when brakes are bled, a transparent flexible tube is fastened to the nipple of the bleeder valve and the valve is opened. In the case where fluid is extracted by gravity or pumping the brake peddle, the valve is left open until the air is seen to pass out of the system; then the valve is closed. In the case where brake fluid is pumped into the system at the wheel cylinder, the system is adequately purged of air, but since the original equipment manufacturers (O.E.M.s) do not provide an annular seal or O-ring on the bleeder valve, in both these cases fluid leaks around the threads, drips on tires and rims, damaging them in some cases or just making a mess. In the case where brake fluid is extracted by vacuum, air enters around the threads of the bleeder valve, making it difficult to tell when the air is out of the system.

Bleeder valves with O-ring seals that prevent the threads from leaking are disclosed in U.S. Pat. No. 3,578,258 issued May 11, 1971 to Carlton, U.S. Pat. No. 3,601,358 issued Aug. 24, 1971 to Cruse and U.S. Pat. No. 4,470,577 issued Mar. 26, 1982 to Warwick.

The valve patented by Carlton is designed to be permanently fastened to a tank and could not be configured to function as a brake bleeder. The valve patented by Cruse is designed to be permanently attached to a tank and is to be used only to charge (pressurize) the tank to which it is attached.

The valve patented by Warwick uses an O-ring for the purpose of providing corrosion protection for the bleeder valve threads and then in the process of protecting the valve threads, the O-ring also prevents leakage of air or brake fluid while bleeding the brakes. The problem with the Warwick patent is that it is assigned to an original equipment manufacturer (O.E.M.), namely the General Motors Corporation, which has not put the patent into production. Thus, the consumer or mechanic, when bleeding brakes, is burdened with leaking air or fluid with attendant annoyance or mess and possible damage.

With my invention, the leaky O.E.M. bleeder valve is substituted with a Replacement or AfterMarket Valve Assembly, i.e. parts not manufactured by an O.E.M. This assembly will not leak in the bleeding process. The Replacement Valve Assembly consists of three parts:
1) a body with an exterior thread that matches the O.E.M. thread and seals to the hydraulic cylinder either by a male valve seat or tapered thread. This body also contains a female valve seat, interior threads and a groove to mount an O-ring.
2) a brake bleeder valve with a male valve seat, threads to match those of the body threads above and a smooth diameter section suitable for O-ring sealing.
3) an O-ring to match the above parts. Note, that space permitting, the O-ring could be mounted in a groove in 2) above.
   Objects and Advantages

Accordingly, the main object of my invention is to replace leaky O.E.M. bleeder valves with Replacement Bleeder Valves that will not leak.

A further object of my invention is to produce a bleeder valve small enough that it will not interfere with the operation of the brake and suspension of the vehicle.

Yet another object of my invention is to produce a bleeder valve assembly that is easy to manufacture.

Yet another object of my invention is to produce a bleeder valve assembly that is easy to install.

Yet another object of my invention is prevent damage to the paint or lacquer on rims of automotive vehicles due to brake fluid.

Yet another object of my invention is to prevent damage to aircraft tires due to the leakage of brake fluid.

Yet another object of my invention is to greatly reduce frustration of consumers and mechanics with the uncertainty and mess with O.E.M. brake bleeders.

Further objects and advantages of my invention will become apparent from a consideration of the drawings and ensuing description.

### DESCRIPTIONS OF DRAWINGS

FIG. 1 is a fragmentary cross-section view of the Replacement Bleeder Valve Assembly where sealing to the O.E.M. brake cylinder is by means of a male valve seat.

FIG. 2 is a fragmentary cross-section view of the Replacement Bleeder Valve Assembly where sealing to the O.E.M. is by means of a tapered thread.

FIG. 3 is an end view showing a slot for brake fluid flow through the actuating screw to the valve seat area.

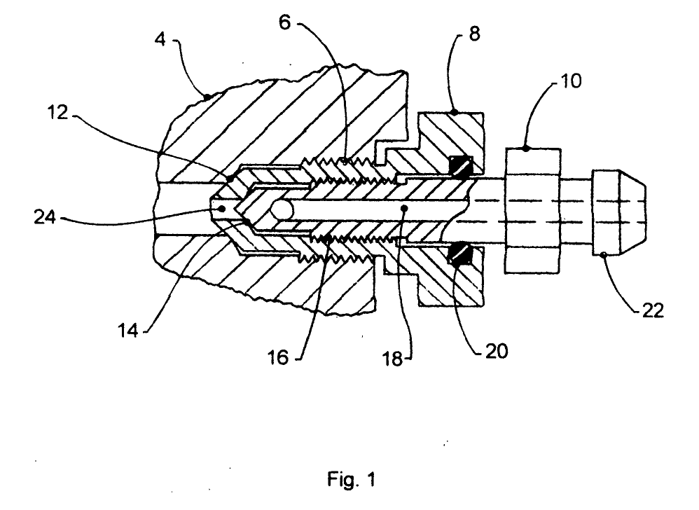

### LIST OF REFERENCE NUMERALS FOR FIG. 1 THROUGH 3

4 . . . . brake cylinder

6 . . . . matching thread between brake cylinder and Replacement valve body

8 . . . . Replacement valve body

10 . . . Replacement bleeder valve

12 . . . seat between brake cylinder and Replacement body

14 . . . seat between Replacement valve body and Replacement bleeder valve

16 . . . bleeder valve actuating thread

18 . . . brake fluid passage hole

20 . . . O-ring

22 . . . Replacement bleeder valve nipple

24 . . . brake fluid passage hole

26 . . . brake fluid passage slot

Description—FIG. 1—First Embodiment

Referring to FIG. 1, a fragmentary cross sectional view of the first embodiment of a Replacement bleeder valve assembly is shown. A brake cylinder is no.4. A matching thread between the brake cylinder and the Replacement valve body is no.6. A Replacement valve body is no.8. A Replacement bleeder valve is no. 10. A seat between the brake cylinder and Replacement valve body is no. 12. A seat between the Replacement valve body and Replacement bleeder valve is no. 14. A bleeder valve actuating thread is no. 16. A brake fluid passage hole is no. 18. A O-ring is no.20. A bleeder valve nipple is no.22. A brake fluid passage hole is no.24.

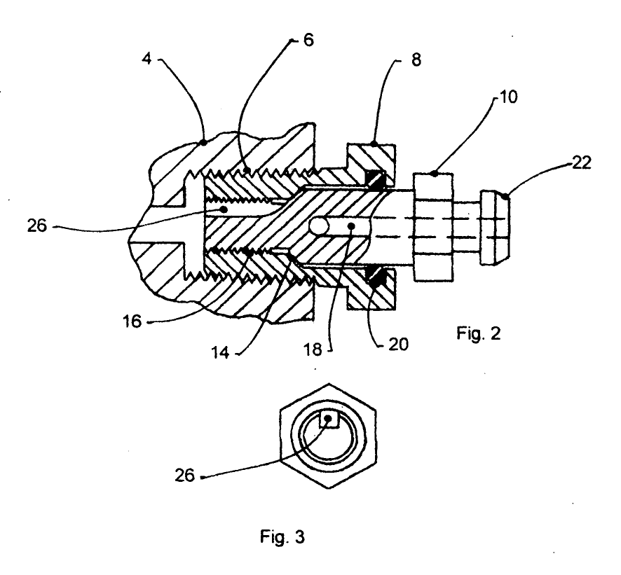

Description—FIGS. 2 and 3—Second Embodiment

Referring to FIG. 2 and FIG. 3, the brake cylinder is no.4. A matching thread between brake cylinder and Replacement valve body is no.6. A Replacement valve body is no.8. A Replacement bleeder valve is no. 10. A seat between the brake cylinder and Replacement vale body is no. 12. A seat between the Replacement valve body and Replacement bleeder valve is no. 14. A bleeder valve actuating thread is no. 16. A brake fluid passage hole is no. 18. A O-ring is no.20. A Replacement valve nipple is no.22. A brake fluid passage slot is no.26.

Operation of the First Embodiment

The O.E.M. bleeder valve is removed from brake cylinder no.4. The Replacement Valve Assembly, consisting of Replacement valve body no.9, Replacement bleeder valve no. 10 and O-ring no.20, is screwed into brake cylinder no.4. The Replacement valve body no.8 is tightened until a seal is obtained at seat no. 12 between brake cvlinder and Replacement valve body. The Replacement Valve Assembly is now ready tor operation i.e., a tube may be attached to Replacement bleeder valve nipple no.22 and seat no.14 between Replacement valve body and Replacement bleeder valve can be opened or closed by a few turns of Replacement bleeder valve no. 10. When the Replacement bleeder valve no. 10 is opened, brake fluid or air may pass in either direction as needed, through brake fluid passage hole no.24, around the beveled end of Replacement bleeder valve no. 10, and though brake fluid passage hole no. 18. O-ring no.20 will then prevent unwanted leakage of the system.

Operation of the Second Embodiment

The O.E.M. bleeder valve is removed from brake cylinder no.4. The Replacement Valve Assembly, consisting of Replacement valve body no.8, Replacement bleeder valve no. 10 and O-ring no.20, is screwed into brake cylinder no.4. Because, in this case, the matching thread between brake cylinder and Replacement bleeder valve no.6 is a tapered or pipe thread, the seal between the brake cylinder no.4 and the Replacement valve body no.8 is made by screwing the Replacement body no.8 tightly into brake cylinder no.4. The Replacement Valve Assembly is now ready for operation. A tube may now be attached to Replacement bleeder valve nipple no.22. The Replacement bleeder valve no. 10 can be unscrewed a few turns allowing brake fluid or air to pass in either direction through brake fluid passage slot no.26, the seat between Replacement valve body and Replacement bleeder valve no. 14, and brake fluid passage no. 18. O-ring no.20 will then prevent unwanted leakage of the system.

Conclusion, Ramifications and Scope

Thus the reader will see that the Replacement or AfterMarket Leak-Proof Brake Bleeder is a simple, economical, easily applied modification to original equipment manufacturer's brake cylinders on automobiles and other vehicles. The reader will also see that my invention will prevent leakage of air with its attendant frustration or the leakage of brake fluid with possible damage to the vehicle and certain mess.

While my above description contains many specificities, these should not be construed as limitations on the scope of the invention but rather as an exemplification of the embodiments thereof. Many other variations are possible. For instance the internal arrangement of parts nos. 10 within Replacement body no.8 can be interchanged between FIG. 1 and FIG. 2. Further, in cases where the O.E.M. bleeder valve is very small in diameter Replacement bleeder valve no.10 may be mounted externally. Another variant would use O-ring no.20 mounted in Replacement bleeder valve no.10 where the diameter is large enough to accommodate it.

Accordingly, the scope of the invention should be determined not by the embodiments illustrated, but by the appended claims and their legal equivalents.

1. I claim a replacement or aftermarket leak-proof brake bleeder comprising:
a. a replacement valve body that seals into the original equipment manufacturer's brake cylinder and contains a valve seat and, brake fluid passages,
b. a replacement bleeder valve with a valve seat for sealing with said valve seat above and, that has brake fluid passage holes or slots as needed and, is secured in said replacement valve body above,
c. an O-ring secured between said replacement valve body above and said replacement bleeder valve above, thereby preventing the leakage of brake fluid or air.
